(19) United States
(12) Patent Application Publication
(10) Pub. No.: US 2024/0394518 A1
(43) Pub. Date: Nov. 28, 2024

(54) MACHINE LEARNING MODEL GENERALIZATION

(71) Applicant: Cognata Ltd., Rehovot (IL)

(72) Inventors: Dan ATSMON, Rehovot (IL); Alon Avraham ATSMON, Kiryat Ono (IL)

(73) Assignee: Cognata Ltd., Rehovot (IL)

(21) Appl. No.: 18/675,239

(22) Filed: May 28, 2024

Related U.S. Application Data
(60) Provisional application No. 63/469,406, filed on May 28, 2023.

(51) Int. Cl. G06N 3/0475; B60W 60/00

(52) U.S. Cl. CPC G06N 3/0475; B60W 60/00; B60W 2554/00; B60W 2555/20

(57) ABSTRACT

A method for generating training data for a machine learning model comprising: accessing a plurality of output values of a machine learning model computed in response to a plurality of input data samples; analyzing the plurality of output values and the plurality of input data samples to compute a plurality of required data sample characteristics associated with at least one unsatisfactory output value of the plurality of output values; generating at least one new input data sample by providing a data generator with a plurality of generation constraints comprising the plurality of required data sample characteristics; and adding the at least one new input data sample to a data repository for producing training data for the machine learning model; wherein the at least one new input data sample comprises at least part of a simulated driving environment for training the machine learning model to operate in an autonomous automotive system.

### RELATED APPLICATION

This application claims the benefit under 35 USC § 119 (e) of priority of U.S. Provisional Patent Application No. 63/469,406 filed on May 28, 2023, the contents of which are incorporated herein by reference in their entirety.

### FIELD AND BACKGROUND OF THE INVENTION

Some embodiments described in the present disclosure relate to a machine learning model and, more specifically, but not exclusively, to a neural network.

Machine learning is a field that focuses on the development of algorithms and models that enable computers or machines to learn and make predictions or take actions without being explicitly programmed. A key idea behind machine learning is to enable computers to learn from data and to adapt and improve their behavior or performance based on that learning. Instead of explicitly programming rules or instructions, a machine learning model can automatically adjust its internal parameters to improve its performance on a given task. The term training, in the field of machine learning, refers to a process of teaching a machine learning model to make accurate predictions or classifications by learning patterns and relationships from a given dataset. Training involves presenting a machine learning model with a set of data samples, known as training data, and allowing the machine learning model to adjust its internal parameters (or weights) based on the patterns it discovers in the data. Many training methods involve executing multiple iterations using a given training data set.

For brevity, unless otherwise noted the term “model” is used to mean “a machine learning model” and the terms are used interchangeably. A neural network is one example of a machine learning model. There exist a variety of types of neural networks, including (but not limited to) Convolutional Neural Networks (CNN), Recurrent Neural Networks (RNN), Long Short-term Memory models, transformer based Large Language Models (LLM) and Generative Adversarial Networks (GAN). In addition to neural networks, there exist myriad types of machine learning models, including but not limited to Linear Regression models, Logistic Regression models, Decision Tree models, Random Forest models, Support Vector Machine models, Bayes models, and Hidden Markov Models (HMM).

In the field of machine learning, the term generalization refers to a machine learning model's ability to adapt properly to new and previously unseen data that is drawn (curated) from the same distribution of data from which the training data is drawn. Real-world data, i.e. data captured in one or more physical environments, can be dynamic, with data patterns changing over time compared to the training data with which a model was trained. In addition, real-world data often contains variations, noise, and uncertainties compared to the training data. Good generalization of the model ensures that the model can accurately handle previously unseen real-world data, increasing accuracy of its output and thus increasing the model's usability in real-world environments.

### SUMMARY OF THE INVENTION

It is an object of some embodiments described in the present disclosure to provide a system and a method for improving generalization of a machine learning model by augmenting a data repository from which training data is curated with one or more new data samples that are generated according to one or more required data sample characteristics. Optionally, the one or more required data sample characteristics are computed by analyzing performance of the machine learning model, for example by analyzing a plurality of output values of the model computed by the model in response to a plurality of input data samples. Optionally the one or more new input data samples comprise at least part of a simulated driving environment for training the model to operate in an autonomous automotive system. Augmenting a data repository from which training data is curated with one or more new data samples that are generated according to required data sample characteristics increases the likelihood of the curated training data accurately representing real world data, and thus increases performance of a machine learning model trained using the curated training data, for example increasing accuracy of the model's output and additionally or alternatively increasing precision of the model's output. Increasing performance of a machine learning model trained using the curated data increases usability of a system in which the machine learning model is installed. Computing the required data sample characteristics based on the model's response to a plurality of input data samples increases accuracy of identifying data sample characteristics that are not well represented in the data repository.

The foregoing and other objects are achieved by the features of the independent claims. Further implementation forms are apparent from the dependent claims, the description and the figures.

According to a first aspect, a method for generating training data for a machine learning model comprises: accessing a plurality of output values of a machine learning model computed in response to a plurality of input data samples; analyzing the plurality of output values and the plurality of input data samples to compute a plurality of required data sample characteristics associated with at least one unsatisfactory output value of the plurality of output values; generating at least one new input data sample by providing a data generator with a plurality of generation constraints comprising the plurality of required data sample characteristics; and adding the at least one new input data sample to a data repository for producing training data for the machine learning model; wherein the at least one new input data sample comprises at least part of a simulated driving environment for training the machine learning model to operate in an autonomous automotive system.

According to a second aspect, a system for generating training data for a machine learning model comprises: an analyzer component configured for: accessing a plurality of output values of a machine learning model, computed thereby in response to a plurality of input data samples; and analyzing the plurality of output values and the plurality of input data samples to compute a plurality of required data sample characteristics associated with at least one unsatisfactory output value of the plurality of output values; and a data generator connected to the analyzer component and configured for: generating at least one new input data sample using a plurality of generation constraints comprising provided therewith, where the plurality of generation constraints comprises the plurality of required data sample characteristics; and adding the at least one new input data sample to a data repository for producing training data for the machine learning model; wherein the at least one new input data sample comprises at least part of a simulated driving environment for training the machine learning model to operate in an autonomous automotive system.

According to a third aspect, a software product for generating training data for a machine learning model comprises: a non-transitory computer readable storage medium; first program instructions for accessing a plurality of output values of a machine learning model computed in response to a plurality of input data samples; second program instructions for analyzing the plurality of output values and the plurality of input data samples to compute a plurality of required data sample characteristics associated with at least one unsatisfactory output value of the plurality of output values; third program instructions for generating at least one new input data sample by providing a data generator with a plurality of generation constraints comprising the plurality of required data sample characteristics; and fourth program instructions adding the at least one new input data sample to a data repository for producing training data for the machine learning model; wherein the at least one new input data sample comprises at least part of a simulated driving environment for training the machine learning model to operate in an autonomous automotive system; and wherein the first, second, third, and fourth program instructions are executed by at least one computerized processor from the non-transitory computer readable storage medium.

According to a fourth aspect, a method for training a machine learning model to operate in an autonomous automotive system comprises: updating a data repository by: accessing a plurality of output values of a machine learning model computed in response to a plurality of input data samples; analyzing the plurality of output values and the plurality of input data samples to compute a plurality of required data sample characteristics associated with at least one unsatisfactory output value of the plurality of output values; generating at least one new input data sample by providing a data generator with a plurality of generation constraints comprising the plurality of required data sample characteristics, wherein the at least one new input data sample comprises at least part of a simulated driving environment for training the machine learning model to operate in an autonomous automotive system; and adding the at least one new input data sample to the data repository for producing training data for the machine learning model; selecting at least one set of training data from the data repository; and providing the at least one set of training data to the machine learning model in a plurality of training iterations.

According to a fifth aspect, a method for an autonomous vehicle comprises: installing a machine learning model in a vehicle, the machine learning model connected to one or more sensors of the vehicle and one or more actuators of the vehicle, wherein the machine learning model is trained to operate in an autonomous automotive system comprising: accessing a plurality of output values of a machine learning model computed in response to a plurality of input data samples; analyzing the plurality of output values and the plurality of input data samples to compute a plurality of required data sample characteristics associated with at least one unsatisfactory output value of the plurality of output values; generating at least one new input data sample by providing a data generator with a plurality of generation constraints comprising the plurality of required data sample characteristics, wherein the at least one new input data sample comprises at least part of a simulated driving environment for training the machine learning model to operate in an autonomous automotive system; adding the at least one new input data sample to a data repository for producing training data for the machine learning model; and providing at least one set of training data to the machine learning model in a plurality of training iterations, where the at least one set of training data is selected from the data repository; and operating at least one of the one or more actuators by the machine learning model in response to one or more signals captured by the one or more sensors.

With reference to the first and second aspects, in a first possible implementation of the first and second aspects the autonomous automotive system is one or more of: an autonomous driving system (ADS), and an advanced driver-assistance system (ADAS).

With reference to the first and second aspects, in a second possible implementation of the first and second aspects generating the at least one new input data sample comprises modifying at least one of the plurality of input data samples. Modifying one or more of the plurality of input data samples reduces complexity of computations required to produce the one or more new input data samples and additionally or alternatively reduces an amount of time required to produce the one or more new input data samples. Optionally, the method further comprises computing a plurality of performance scores using the plurality of output values and the plurality of input data samples, wherein computing the plurality of required data sample characteristics is further according to the plurality of performance scores. Optionally, the plurality of performance scores comprises at least one of: an accuracy score, a precision score, a recall score, an F1 score, and an area under the receiver operating characteristic (ROC) curve. Computing the plurality of required data sample characteristics according to the plurality of performance scores facilitates computing one or more of the required data sample characteristics according to a score indicative of poor performance, thus increasing likelihood of the required data sample characteristics including at least one characteristic not covered sufficiently by the data repository, thus improving usability of the data repository after the one or more new data samples, generated according to the plurality of required data samples are added thereto.

With reference to the first and second aspects, in a third possible implementation of the first and second aspects the method further comprises collecting the plurality of output values during at least one validation session of the machine learning model using the plurality of input data samples. A validation session is for assessing how well the model generalizes to new, unseen data. A validation session using the plurality of input data samples exposes data sample characteristics to which the model responds poorly (unsatisfactorily). Collecting the output values during a validation session of the machine learning model where the validation is using the plurality of input data samples increases accuracy of the plurality of required data sample characteristics and thus improves usability of the data repository after the one or more new data samples, generated according to the plurality of required data samples are added thereto.

With reference to the first and second aspects, in a fourth possible implementation of the first and second aspects the data repository stores a plurality of input data candidates and the method further comprises producing the plurality of input data samples by selecting from the data repository a plurality of input data candidates according to a plurality of curation constraints. Using curation constraint increases the likelihood of the plurality of input data samples covering new, unseen data and thus increases accuracy of identifying the plurality of required data sample characteristics for which to generate new data samples. Optionally, the plurality of curation constraints includes at least one target statistical distribution in a set of input data samples of a set of parameter values of a coverage parameter. Using a target statistical distribution of a set of parameter values of a coverage parameter increases the likelihood of generating training data to cover a rare value of a data sample characteristic, thus increasing accuracy of an output of a model trained with said training data. Optionally, the coverage parameter is one of a set of coverage parameters consisting of: a class of an object, an object attribute, an object attribute value, a data source, a temporal attribute value, a location attribute value, a difficulty classification of an input data sample, an augmentation technique used to create an input data sample, a sharpness value, a contrast value, a color value, a color combination, a color intensity value, a color brightness, a texture, a histogram of a digital image, a distance between objects, an object orientation, an object orientation relative to another object, an amount of objects in an input data sample, a weather attribute value, a velocity of an object, and a motion pattern of an object. Optionally, the plurality of curation constraints includes at least one qualitative characteristic of a set of input data samples. Using qualitative characteristic of a set of input data samples increases the likelihood of gencrating training data to cover a rare composition of objects and object features, thus increasing accuracy of an output of a model trained with said training data. Optionally, the at least one qualitative characteristic comprises at least one of: a semantic context of an object, a composition of a plurality of objects, a plurality of parameter values of a plurality of coverage parameters in an input data sample, a variation between a plurality of compositions of a plurality of objects in the set of input data samples, and a rarity value of a composition of a plurality of objects. Optionally, the method further comprises modifying the plurality of curation constraints according to the plurality of required data sample characteristics. Modifying the plurality of curation constraints according to the plurality of required data sample characteristics increases the likelihood of curating training data covering areas where the model previously performed poorly, thus increasing accuracy of an output of the model trained used said training data.

With reference to the first and second aspects, in a fifth possible implementation of the first and second aspects the method further comprises: collecting raw data from a plurality of data sources; and adding to the data repository at least one other input data sample generated using at least some of the raw data. Optionally, the plurality of data sources comprises at least one of: a database, a sensor, an application programming interface and a human-machine interface. Generating one or more input data samples generated using at least some raw data collected from a plurality of data sources increases variety of data in the data repository, increasing the likelihood that a model trained with training data selected from the data repository will generalize correctly to new and unseen data and thus increases accuracy of an output of said model.

With reference to the first and second aspects, in a sixth possible implementation of the first and second aspects adding the at least one new input data sample to the data repository comprises providing the at least one new input data sample to a data manager.

With reference to the first and second aspects, in a seventh possible implementation of the first and second aspects the method further comprises training the machine learning model using one or more sets of training data selected from the data repository. Optionally, the data repository stores a plurality of input data candidates and at least one of the one or more sets of training data is produced by selecting from the data repository another plurality of input data candidates according to another plurality of curation constraints. Training the model with training data selected from the data repository after adding the one or more new input data samples increases the likelihood that the model will generalize correctly to new and unseen data and thus increases accuracy of an output of the model.

With reference to the first and second aspects, in an eighth possible implementation of the first and second aspects the at least one new input data sample comprises at least one of: a digital image, a digital video, and a simulated signal simulating a signal captured from a sensor.

With reference to the first and second aspects, in a ninth possible implementation of the first and second aspects the method further comprises: computing a plurality of visual features by analyzing an identified repository of data samples comprising a plurality of digital images captured in one or more physical environments; and computing at least one dataset score using the plurality of visual features and at least one additional set of training data selected from the data repository, where the at least one dataset score is indicative of an expected performance score of the machine learning model in response to input data when the machine learning model is trained using the at least one additional set of training data. Optionally, computing the plurality of required data sample characteristics is further according to the at least one dataset score and the plurality of visual features. Computing a plurality of visual features by analyzing a plurality of digital images captured in one or more physical environments allows identifying real world visual features. Computing one or more dataset scores using the plurality of visual features allows indicating how well the one or more additional sets of training data correctly train a model to generalize to new and unseen data. Computing the plurality of required data sample scores further according to said plurality of visual features and the one or more dataset scores increases the likelihood of the plurality of required data sample characteristics including at least one characteristic not covered sufficiently by the data repository, thus improving usability of the data repository after the one or more new data samples, generated according to the plurality of required data samples are added thereto. Optionally, the plurality of visual features comprises at least one of: an object attribute, an object attribute value, a sharpness value, a contrast value, a color value, a color combination, a color intensity value, a color brightness, a texture, a histogram of a digital image, a distance between objects, an object orientation, an object orientation relative to another object, an amount of objects in an input data sample, a weather attribute value, a velocity of an object, a semantic context of an object, an edge of an object, a positional relationship between two or more objects, and a motion pattern of an object.

With reference to the first and second aspects, in a tenth possible implementation of the first and second aspects the data repository stores a plurality of input data candidates and the system further comprises a curation component, configured for producing one or more sets of input data samples, each produced by selecting from the data repository a plurality of input data candidates according to a plurality of curation constraints. Optionally, the system further comprises a data manager connected to the data repository and configured for collecting and managing raw data from a plurality of data sources. Optionally, the system further comprises a training subsystem, configured for training the machine learning model. Optionally, the system further comprises a scoring component configured for: computing a plurality of performance scores using the plurality of output values and the plurality of input data samples; and providing the plurality of performance scores to the analyzer component; wherein computing the plurality of required data sample characteristics is further according to the plurality of performance scores.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments pertain. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic block diagram of an exemplary system, according to some embodiments;

FIG. 2 is a flowchart schematically representing an optional flow of operations, according to some embodiments;

FIG. 3 is a flowchart schematically representing another optional flow of operations, according to some embodiments; and

FIG. 4 is a flowchart schematically representing an optional flow of operations for training a machine learning model, according to some embodiments.

### DESCRIPTION OF SPECIFIC EMBODIMENTS OF THE INVENTION

The following description focuses on supervised learning for training a machine learning model, however the systems and methods described herewithin may be applied to other training paradigms.

Performance of a machine learning model is measured using a variety of metrics. One example of a metric used to score performance of a model is accuracy, measuring the proportion of correct predictions made by the model compared to the total number of predictions. Another example of a metric is precision, measuring the proportion of true positive predictions (correctly predicted positive instances) out of all positive predictions made by the model. Some other metrics include Recall (Sensitivity or True Positive Rate), Specificity (True Negative Rate), Mean Squared Error (MSE), and F1 Score, combining precision and recall into a single metric that balances both measures.

Since the early days of machine learning there is an understanding that performance of a machine learning model depends on the variety of data used to train the model, with greater variety of data being linked to a better performing model.

To achieve a large variety of scenarios in training data used to train the model, it is common practice to use large data sets as training data. There exists in machine learning an informal “one in ten” rule of thumb, suggesting that for each parameter in a model at least ten times as many training samples should be used to ensure adequate model generalization. However, increasing the amount of data samples in the training data increases the amount of time required for each training iteration using the training data, increasing the cost of training the model. To balance between the amount of samples required to train a model and the cost of training the model, it is increasingly common practice to curate training data sets, selecting a plurality of data samples from a distribution of data which may be very large according to a set of constraints that are characteristic of a task the model is expected to handle.

Still, despite curation aimed at generating training data that provides the model with a large variety of scenarios relevant to the task, the field of machine learning suffers from overfitting, where a model performs well on training data but poorly on previously unseen data, even when the unseen data is drawn from the same distribution of data from which the training data was curated. One possible cause of overfitting is when the model learns noise in the training data instead of the underlying patterns. This results in poor performance on unseen data. High-quality training data that accurately represents the real-world scenarios relevant to the task of the model is crucial for training the model to generalize well. If the training data is biased, unrepresentative, or of poor quality, it can negatively impact the model's accuracy, even with a large amount of data in the training data.

One possible solution for improving a model's generalization is performing gradient descent on the model, however gradient descent is a long process and as models' complexity increases this is not a viable solution.

Successful curation for machine learning training data attempts to produce training data that is of high-quality and representative of real-world scenarios that the model is expected to handle. In addition, curation aims to capture various conditions, edge cases and potential challenges that the model may be required to handle. In addition, curation processes attempt to produce training data that is balanced, based on one or more characteristics (coverage parameters). Some examples of a coverage parameter include: a class of an object, an object attribute, an object attribute value, a data source, a temporal attribute value, a location attribute value, a difficulty classification of an input data sample, an augmentation technique used to create an input data sample, a sharpness values, a contrast value, a color value, a color combination, a color intensity value, a color brightness, a texture, a histogram of a digital image, a distance between objects, an object orientation, an object orientation relative to another object, an amount of objects in an input data sample, a weather attribute value, a velocity of an object, and a motion pattern of an object.

As used herewithin, the term “distribution of data” is used to mean a plurality of data samples. Thus, the term “adding to a distribution of data” is used herewithin to mean “adding one or more data samples to a plurality of data samples”.

Some existing solutions attempt to improve the curation process, trying to draw better training sets from the existing distribution of data. Such solutions try to improve quality of the data samples in the training data and improve balance of one or more coverage parameters, however this does not provide the needed improvement in producing generalized models. One cause for this is that improving the curation process achieves local optimization of the existing distribution of data but cannot overcome deficiencies of the distribution of data itself, when the distribution of data is biased, unrepresentative, of poor quality, or any combination thereof.

The present disclosure, in some embodiments described herewithin, proposes improving training data by augmenting the distribution of data from which the training data is curated. In such embodiments the present disclosure proposes adding to the distribution of data one or more data samples that are high-quality and additionally or alternatively that improve the balance of one or more coverage parameters in the distribution of data, for example by adding one or more data samples that include one or more under-represented characteristics. Improving the quality of some data samples in the distribution of data, and additionally or alternatively improving the balance of one or more coverage parameters in the distribution of data, increases the likelihood that new training data curated from the augmented distribution of data will include higher quality samples and will be better balanced with respect to the one or more coverage parameters compared to other training data curated from the non-augmented distribution of data. This provides the benefit of reducing the risk of overfitting in a model trained using the new training data curated from the augmented distribution of data compared to the model when trained using the other training data, increasing performance of the model and thus increasing the model's usability in real-world scenarios. Optionally, the curation process is additionally modified. For example, the curation process may be modified to enforce a predefined diversity criterion giving more importance to at least one under-represented characteristic or the one or more under-represented characteristic, for example by adjusting one or more weights of the curation process.

To augment the distribution of data, in some embodiments described herewithin, the present disclosure proposes analyzing performance of a trained model to identify one or more required data sample characteristics that are associated with one or more unsatisfactory output values of the model computed by the model in response to a plurality of input data samples, and generating one or more new input data samples according to a plurality of generation constraints that include the one or more required data sample characteristics. An unsatisfactory output value may be an incorrect classification or prediction. An unsatisfactory output value may be an incorrect control instruction. An unsatisfactory output value may be a confidence value that is less than an expected confidence threshold value. Optionally, analyzing the performance of the trained model comprises analyzing the plurality of input data samples and a plurality of output values of the model. Optionally, the plurality of required data sample characteristics is computed by analyzing the performance of the trained model. Optionally, a data sample characteristic comprises a semantic characteristic of a data sample, for example a color of an object. Optionally, a data sample characteristic comprises a perceived characteristic of a data sample, i.e. an indication of one or more values captured by a sensor. One example of a perceived characteristic is a color of an object that is captured differently in different lighting conditions, for example a maroon object that is captured as black in low lighting conditions, or an object partially shaded such that a common color of the object is captured as a plurality of colors. Another example of a perceived characteristic is glare that effects how an object is captured by a sensor. Optionally, a data sample characteristic is a qualitative characteristic of a set of input data samples. A qualitative characteristic is a indicative of a semantic quality of the set of input data samples, where a semantic quality may be a quality that is not a statistical value. A qualitative characteristic may be a non-numerical measure of a degree of interest of a set of input data samples. For example, a qualitative characteristic may be a semantic context of an object, for example “a car with a left indicator light flashing” or “a car driving through a splashing puddle”. Another example of a qualitative characteristic is a composition of a plurality of objects, for example “two lanes of vehicles”. Another example of a qualitative characteristic is a variation between a plurality of compositions of a plurality of objects in the set of input data samples, for example “at least three different combinations of vehicle sizes” or “an amount of different distances between a pedestrian and a curb”. Some other examples of a qualitative characteristic include, but are not limited to, a plurality of parameter values of a plurality of coverage parameters, for example a set including a vehicle color and a vehicle size, and a rarity value of a composition of a plurality of objects, for example “less than one percent of the samples have three vehicles in a row”.

Further in such embodiments, the present disclosure proposes adding the one or more new input data samples to the distribution of data such that when producing the new training data the one or more new input data samples are available to a curation process producing the new training data.

Analyzing performance of the trained model allows augmenting the distribution of data with one or more new input data samples that address areas where the model's performance is identified to be weak. This is simpler to perform and more likely to provide the required coverage compared to generating training data that provides full coverage. For example, analyzing performance of the trained model using the plurality of input data samples may reveal that the model has weak performance in response to samples comprising a particular combination of distances between objects. In another example, analyzing performance of the trained model using the plurality of input data samples may reveal that the model has weak performance in response to sample comprising a particular combination of colors. In another example, a model's poor performance may be associated with a particular combination of object orientation and particular lighting conditions. Such a variety of complex conditions is difficult to anticipate and cover in a comprehensive coverage function and so coverage functions are inherently prone to be inadequate. Generating new input data samples based on identified low-performance areas of the model instead of according to a coverage function provides the technical benefit of increasing coverage of training data at a lower computation cost and greater accuracy (i.e. correctly addressing under-covered characteristics) than when generated according to a coverage function.

Optionally, analyzing performance of the trained model comprises using a plurality of performance scores computed according to the plurality of input data samples and the plurality of output values of the model.

In addition, in some embodiments the present disclosure proposes additionally or alternatively computing at least one of the one or more required data sample characteristics according to one or more visual features of a repository of real world data, i.e. a plurality of data samples captured in one or more physical environments. Optionally, a visual feature is a data sample characteristic, for example a semantic characteristic or a perceived characteristic as described above. Optionally, a visual feature is a qualitative characteristic, as described above. Using one or more visual features of a repository of real world data to identify the one or more required data sample characteristics increases the likelihood that the augmented distribution of data accurately represents real world data.

The term “autonomous driving system” (ADS) refers to a vehicle that is capable of sensing its environment and moving safely with some human input. The term “advanced driver-assistance system” (ADAS) refers to a system that aids a vehicle driver while driving by sensing its environment. A vehicle comprising an ADAS may comprise one or more sensors, each capturing a signal providing input to the ADAS. Some examples of a sensor are an image sensor, such as a camera, an acceleration sensor, a velocity sensor, an audio sensor, a radar, a LIDAR sensor, an ultrasonic sensor, a thermal sensor, and a far infra-red (FIR) sensor. A camera may capture visible light frequencies. A camera may capture invisible light frequencies such as infra-red light frequencies and ultra-violet light frequencies.

Optionally, the machine learning model is trained to operate in an autonomous automotive system, for example an ADS and additionally or alternatively an ADAS. Optionally, the one or more new input data samples comprise at least part of a simulated data scenario. Optionally, a simulated data scenario comprises data simulating data captured by one or more sensors in a physical environment. For example, a simulated driving scenario may include one or more of: a digital image, a digital video, a simulated signal simulating a signal captured from a sensor.

For brevity, the following disclosure focuses on training a machine learning model, however the methods and systems described below may additionally or alternatively be used for testing a machine learning model, additionally or alternatively validating a machine learning model, and additionally or alternatively verifying a machine learning model. Furthermore, while the following disclose focuses on machine learning for an autonomous automotive system, the methods and systems described below may additionally or alternatively be used for other systems and devices, some examples include: an autonomous appliance, for example a robotic cleaner, a robotic medical tool and a robotic manufacturing device.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code, natively compiled or compiled just-in-time (JIT), written in any combination of one or more programming languages, including an object oriented programming language such as Smalltalk, C++, Java, Object-Oriented Fortran or the like, an interpreted programming language such as JavaScript, Python or the like, and conventional procedural programming languages, such as the “C” programming language, Fortran, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), a coarse-grained reconfigurable architecture (CGRA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

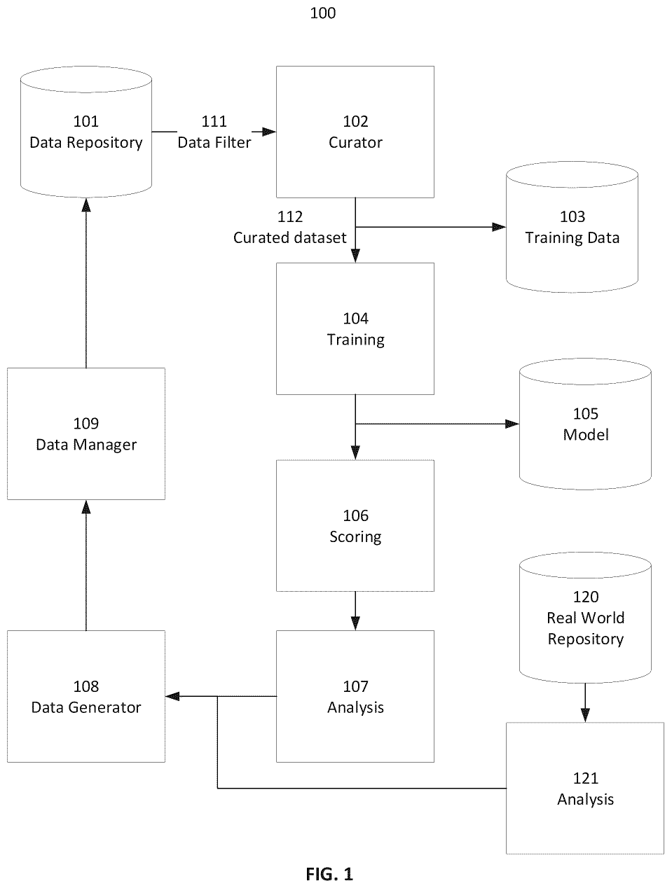

Reference is now made to FIG. 1, showing a schematic block diagram of an exemplary system 100, according to some embodiments. Optionally, system 100 comprises one or more analyzer component 107 (analyzer 107) connected to one or more data generator 108 (data generator 108). Optionally, data generator 108 comprises a simulation engine for generating synthetic data. One example of a simulation engine is a driving scenario simulation engine, configured to generate synthetic data simulating one or more signals captured in a physical driving environment equivalent to a simulated driving environment created by the simulation engine. Optionally, data generator 108 comprises one or more generative machine learning models. Optionally, the one or more generative machine learning models are at least part of a Generative Adversarial Network (GAN).

Optionally, data generator 108 is connected to one or more data repository 101 (data repository 101), optionally via one or more data manager 109 (data manager 109). Optionally, data repository 101 stores a plurality of input data candidates. An input data candidate is an input data sample that is a candidate to be included in a plurality of input data samples of training data. Optionally, the plurality of input data candidates is a distribution of data. Optionally, system 100 comprises one or more curation component 102 (curator 102), optionally connected to data repository 101 optionally via one or more data filter 111. Optionally, curator 102 is connected to one or more training subsystem 104 (training subsystem 104). Optionally, curator 102 provides training subsystem 104 with one or more curated datasets 112, optionally comprising training data 103. Optionally, curator 102 is configured for cleaning, filtering, normalizing, or any combination thereof of at least some of the plurality of input data sample candidates stored in data repository 101.

Optionally, training subsystem 104 is configured for training one or more machine learning model 105 (model 105), optionally using training data 103. Optionally, model 105 comprises at least one neural network. Optionally, the at least one neural network is a deep learning neural network, for example a CNN, a RNN of a transformer based neural network. Optionally, model 105 is trained to handle one or more model tasks. Some examples of a model task are object recognition, semantic segmentation, depth estimation and motion prediction. Optionally, model 105 is trained to perform a model task of an autonomous system, for example an autonomous automotive system such as an ADAS or an ADS. An example of a model task of an autonomous automotive system is perception, i.e. identification and additionally or alternatively classification of one or more objects in input data. Another example of a model task of an autonomous automotive system is prediction, for example predicting a moving object's movement pattern, for example movement of a pedestrian or a vehicle. Yet another example of a model task of an autonomous automotive system is control, for example generating an instruction to control a steering mechanism of a vehicle. Model 105 may be trained to perform a model task of a robotics system. Other examples of a system for which model 105 is trained include, but are not limited to, medical imaging and natural language processing.

Optionally, training subsystem 104 is connected to analyzer 107. Optionally, subsystem 104 is connected to one or more scoring component 106 (scoring component 106). Optionally scoring component 106 is connected to analyzer 107.

Optionally, system 100 comprises at least one user interface for enabling user input and interaction with a user, optionally to do one or more of the following: refine a predefined diversity criterion, adjust a constraint parameter, and visualize one or more performance metrics of model 105.

Optionally, system 100 comprises one or more other analyzer component 121 (other analyzer 121) connected to one or more identified repositories 120 of real world data (real world repository 120). Some examples of a repository of real world data include ImageNet, Common Objects in Context (COCO), and Pexels. Optionally, analyzer 107 is other analyzer 121.

Optionally, one or more of the plurality of components of system 100 are a hardware component. Optionally, one or more of the plurality of components of system 100 comprise at least one set of computer instructions executed by one or more processing circuitries. Optionally, one or more of the plurality of components of system 100 comprise one or more software objects executed by one or more hardware processors (not shown).

To generate training data, in some embodiments system 100 implements the following optional method.

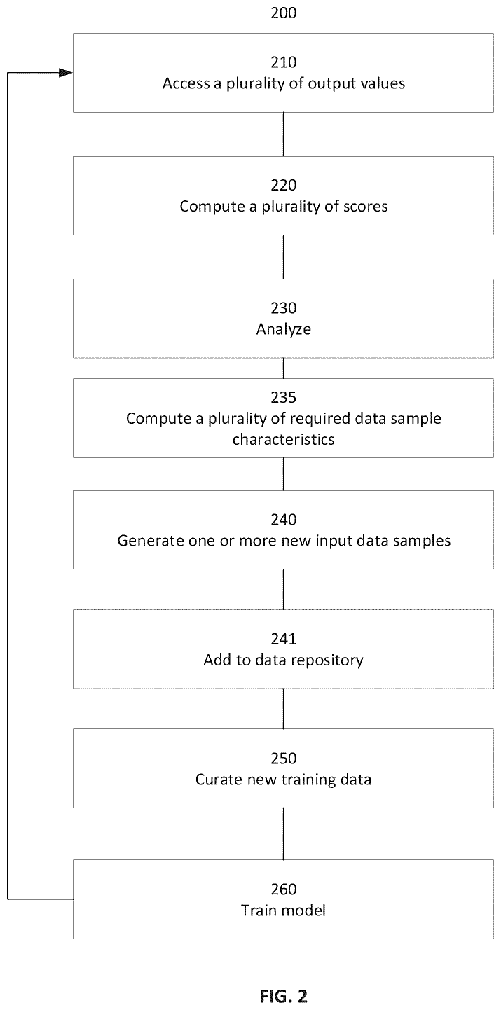

Reference is now made also to FIG. 2, showing a flowchart schematically representing an optional flow of operations 200, according to some embodiments.

Optionally, in 210 analyzer 107 accesses a plurality of output values of model 105, computed in response to a plurality of input data samples of training data 103. Optionally, the plurality of output values are collected during one or more validation sessions of model 105 using the plurality of input data samples. Optionally the plurality of input data samples are produced by curator 102 by selecting from data repository 101 a plurality of input data candidates according to a plurality of curation constraints. Optionally, the plurality of curation constraints pertain to at least one level of features that is not a highest level of features of model 105. A feature in a machine learning model is an individual measurable property or characteristic of a phenomenon being observed by the model and is used by the model to compute the model's output, for example a prediction or a classification. In the context of machine learning models where features are learned hierarchically through multiple layers of the model, a level of features refers to a layer of abstraction of a plurality of abstraction layers of the model. A higher level of abstraction represents more complex patterns than a lower level of abstraction. Thus, the plurality of curation constraints optionally pertain to at least one level of features that is not a highest level of abstraction of model 105. Optionally, the plurality of curation constraints comprise one or more physical property constraints, for example constraining placement of an object in an image, for example that a road sign must touch the ground. Optionally, for at least one set of parameter values of a coverage parameter, the plurality of curation constraints includes at least one target distribution in a set of input data samples of said set of parameter values. The set of parameter values may comprise a discrete set of values. Optionally the set of parameter values comprises one or more ranges of values. Some examples include, but are not limited to, a discrete set of colors, a range of humidity values, a range of distances between objects, and a discrete set of locations. Optionally, the plurality of curation constraints comprises one or more qualitative characteristics of the set of input data samples, for example a semantic context of an object.

Optionally, scoring component 106 accesses the plurality of output values and in 220 scoring component 106 optionally computes a plurality of performance scores. Optionally, component 106 computes the plurality of performance scores using the plurality of output values and the plurality of input data samples. Optionally, the plurality of performance scores are according to one or more data values of the plurality of input data samples, as opposed to a semantic definition of the plurality of input data samples. Optionally, the plurality of performance scores are according to one or more semantic definitions of the plurality of input data samples. Optionally, scoring component 106 provides the plurality of performance scores to analyzer 107.

In 230, analyzer 107 optionally analyzes the plurality of output values and the plurality of input data samples to optionally compute in 235 one or more required data sample characteristics. Optionally, the one or more required data sample characteristics are associated with one or more unsatisfactory output values of the plurality of output values. Optionally, analyzer 107 computes the one or more required data sample characteristics further using the plurality of performance scores computed by scoring component 106. Some examples of a performance score include an accuracy score, a precision score, a recall score, an F1 score, and an area under the receiver operating characteristic (ROC) curve.

In some embodiments computing the one or more required data sample characteristics comprises additionally, or alternatively, using a plurality of visual features of a real world repository. In such embodiments, system 100 may further implement the following optional method.

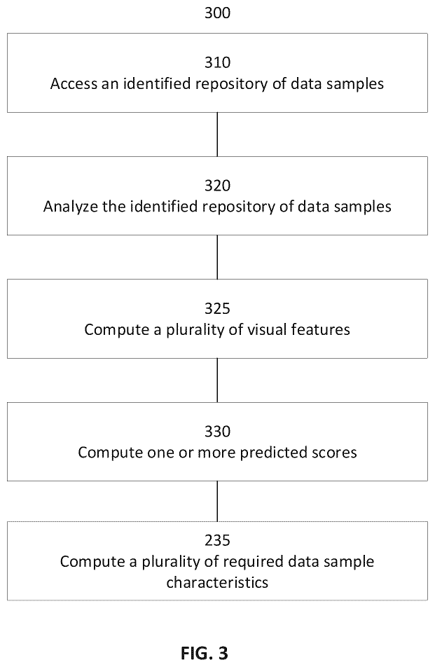

Reference is now made also to FIG. 3, showing a flowchart schematically representing another optional flow of operations 300, according to some embodiments. In such embodiments, in 310 other analyzer 121 accesses an identified repository of data samples. Optionally, the identified repository of data samples comprises a plurality of digital images captured in one or more physical environments. In 320, other analyzer 320 optionally analyzes the identified repository of data samples, for example comprising analyzing the plurality of digital images. In 325, other analyzer 121 optionally computes a plurality of visual features, optionally according to the analysis of the plurality of digital images in 320. Some examples of a visual feature include a texture, a color, a semantic context of an object, a histogram of a digital image, a brightness value of a digital image and a positional relationship between two or more objects.

Optionally, in 330 other analyzer 121 computes one or more dataset scores, optionally using the plurality of visual features and one or more sets of training data selected from data repository 101. Optionally, the one or more dataset scores are indicative of an expected performance score of model 105 in response to input data, where model 105 is trained using the one or more sets of training data. Optionally, the one or more dataset scores are indicative of a visual feature of the plurality of visual features that is missing or insufficiently covered in the one or more sets of training data. In such embodiments, the one or more dataset scores are indicative of a degree of accuracy of the one or more sets of training data in representing a real world. Some examples of an expected performance score of a model include an accuracy score, a precision score, a recall score, an F1 score, and an area under the receiver operating characteristic (ROC) curve.

Optionally, other analyzer 121 provides the one or more dataset scores, and additionally or alternatively the plurality of visual features to analyzer 107 for computing the plurality of required data sample characteristics. Optionally, the plurality of required data sample characteristics are computed in 235 additionally according to the one or more dataset scores. Optionally, the plurality of required data sample characteristics are computed in 235 alternatively according to the one or more dataset scores. Optionally, the plurality of required data sample characteristics comprises at least one of the plurality of visual features.

Reference is now made again to FIG. 2. In 240, analyzer 107 optionally provides data generator 108 with a plurality of generation constraints comprising the one or more required data sample characteristics, and data generator 108 optionally generates one or more new input data samples according to the plurality of generation constraints. Optionally, the one or more new input data samples comprise a digital image. Optionally, the one or more new input data samples comprise a digital video. Optionally, the one or more new input data samples comprise a simulated signal simulating a signal captured from a sensor, for example when model 105 is trained to operate in an autonomous automotive environment and the one or more new input data samples comprises at least part of a simulated driving environment. Optionally, the simulated driving environment is used to train model 105, validate model 105, verify model 105, test model 105, or any combination thereof.

Optionally, the one or more new input data samples comprise at least one synthetic input data sample, generated by data generator 108 according to the plurality of generation constraints. Optionally, the plurality of generation constraints comprise a plurality of scene characteristics, for example when the one or more new input data samples comprise at least part of a simulated driving environment. Optionally a scene characteristic is an environmental characteristic, some examples of an environmental characteristic including a time characteristic such as a time of day, a day of week, and a month of year, a weather characteristic for example a temperature value, a fog/smog/air clarity indication value, an amount of precipitation, a type of precipitation, a distribution of precipitation in a scene, a wind velocity and a wind direction, an environment condition characteristic, for example a daylight characteristic value (indicative of a degree of brightness, a degree of cloudiness or an amount of light), an artificial light indication, an amount of light, and an amount of vehicles per amount of time, and a geographic characteristic, for example a location in the world, an incline value, a curve measurement value such as a direction or a radius, and a road horizontal angle.

Optionally a scene characteristic is an object characteristic, defining structural, additionally or alternatively visual, and additionally or alternatively behavioral features of an object in a simulated scene. An object may be a moving object, for example a pedestrian or a vehicle, some examples including a car, a truck, a bicycle, and another motorized vehicle. A pedestrian may be human. A pedestrian may be an animal. Optionally, an object is a static object in a scene, for example a structure such as a building or a bench, a traffic sign, a traffic marking on a road, a curb, and vegetation. Some examples of an object characteristic include: a dimension, a color, a material, a forward velocity, a forward acceleration, a lateral velocity, a lateral acceleration, a direction of movement, a distance from a lane boundary, a distance from another object, an orientation, and a distance from a sensor.

Optionally, the plurality of generation constraints further comprise one or more physical property generation constraints, for example constraining placement of an object in an image, for example when model 105 is trained to operate in an autonomous automotive environment, the one or more required data sample characteristics optionally comprise a constraint that a road sign must touch the ground or that a pedestrian must be on a road or a sidewalk.

Optionally, the plurality of generation constraints comprises one or more qualitative constraints, for constraining a variety of placements of an object in an image.

Optionally, generating the one or more new input data samples comprises modifying at least one of the plurality of input data samples. Modifying an input data sample optionally comprises adding one or more objects into the input data sample. Optionally, modifying an input data sample comprises changing an orientation of one or more objects in the input data sample, for example changing orientation of a traffic sign. Optionally, modifying an input data sample comprises changing an environment characteristic of the input data sample, for example changing a weather condition or a time of day. Optionally, modifying an input data sample comprises changing a color of an object. Optionally, modifying an input data sample comprises changing a distance between two or more objects or a distance between an object and a sensor capturing the scene.

Optionally, generating the one or more new input data samples comprises collecting raw data from a plurality of data sources and adding to data repository 101 one or more other input data samples generated using at least some of the raw data. Some examples of a data source include a database, a sensor, an application programming interface and a human-machine interface.

In 241, the one or more new input data samples are optionally added to data repository 101, optionally by providing the one or more new input data samples to data manager 109.

Optionally, in 250 curator 102 produces new training data, for example one or more new sets of training data, optionally by accessing data repository 101, and in 260 training subsystem 104 optionally trains model 105 using the new training data. Optionally, curator 102 produces the new training data by selecting from data repository 101 a new plurality of input data candidates according to another plurality of curation constraints. Optionally, the plurality of curation constraints are modified according to the plurality of required data sample characteristics, optionally by a management component (not shown) connected to one or more components and subsystems of system 100, for example to analyzer 107, other analyzer 121 and curator 102. Optionally, the other plurality of curation constraints is the modified plurality of curation constraints.

Optionally, method 200 is repeated in each of a plurality of iterations.

In some embodiments, system 100 is used to train model 105. In such embodiments, system 100 implements the following optional method.

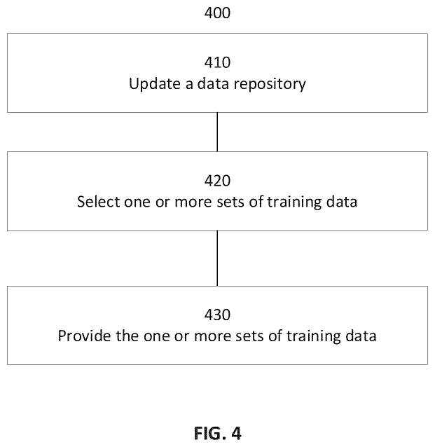

Reference is now made also to FIG. 4, showing a flowchart schematically representing an optional flow of operations 400 for training a machine learning model, according to some embodiments. In such embodiments, in 410 data repository 101 is updated, optionally by system 100 implementing method 200. In 420, optionally curator 102 selects one or more additional sets of training data from data repository 101, optionally according to the plurality of curation constraints. In 430 curator 102 optionally provides the one or more additional sets of training data to model 105, optionally via training subsystem 104, optionally in a plurality of training iterations. Optionally, in 430 training subsystem 104 trains model 105 using the one or more additional sets of training data and additionally or alternatively validates model 105 using the one or more additional sets of training data, tests model 105 using the one or more additional sets of training data, verifies model 105 using the one or more additional sets of training data, or any combination thereof.

When model 105 is trained to operate in an autonomous automotive system, model 105 may be installed in a vehicle, connected to one or more actuators of the vehicle, for example an accelerator, a break or a steering component. Optionally, when installed in a vehicle, model 105 operates the one or more actuators, in response to one or more signals captured by one or more sensors installed in the vehicle. In another example, model 105 is trained to operate in an autonomous manufacturing tool. In this example, model 105 may be connected to one or more other actuators of the autonomous manufacturing tool, for example a steering component or a drill. In this example model 105 operates the one or more other actuators in response to one or more other signals captured by one or more other sensors installed in the autonomous manufacturing tool. Some examples of an autonomous manufacturing tool include a smart packing robot and a smart assembly system.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models and input data samples will be developed and the scope of the terms model and “input data sample” are intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section 10 headings are used, they should not be construed as necessarily limiting. In addition, any priority document(s) of this application is/are hereby incorporated herein by reference in its/their entirety.

What is claimed is:

1. A method for generating training data for a machine learning model comprising:
accessing a plurality of output values of a machine learning model computed in response to a plurality of input data samples;
analyzing the plurality of output values and the plurality of input data samples to compute a plurality of required data sample characteristics associated with at least one unsatisfactory output value of the plurality of output values;
generating at least one new input data sample by providing a data generator with a plurality of generation constraints comprising the plurality of required data sample characteristics; and
adding the at least one new input data sample to a data repository for producing training data for the machine learning model;
wherein the at least one new input data sample comprises at least part of a simulated driving environment for training the machine learning model to operate in an autonomous automotive system.

2. The method of claim 1, wherein the autonomous automotive system is one or more of: an autonomous driving system (ADS), and an advanced driver-assistance system (ADAS).

3. The method of claim 1, wherein generating the at least one new input data sample comprises modifying at least one of the plurality of input data samples.

4. The method of claim 1, further comprising:
computing a plurality of performance scores using the plurality of output values and the plurality of input data samples;
wherein computing the plurality of required data sample characteristics is further according to the plurality of performance scores.

5. The method of claim 4, wherein the plurality of performance scores comprises at least one of: an accuracy score, a precision score, a recall score, an F1 score, and an area under the receiver operating characteristic (ROC) curve.

6. The method of claim 1, wherein the data repository stores a plurality of input data candidates; and
wherein the method further comprises producing the plurality of input data samples by selecting from the data repository a plurality of input data candidates according to a plurality of curation constraints.

7. The method of claim 6, wherein the plurality of curation constraints includes at least one target statistical distribution in a set of input data samples of a set of parameter values of a coverage parameter.

8. The method of claim 7, wherein the coverage parameter is one of a set of coverage parameters consisting of:
a class of an object, an object attribute, an object attribute value, a data source, a temporal attribute value, a location attribute value, a difficulty classification of an input data sample, an augmentation technique used to create an input data sample, a sharpness value, a contrast value, a color value, a color combination, a color intensity value, a color brightness, a texture, a histogram of a digital image, a distance between objects, an object orientation, an object orientation relative to another object, an amount of objects in an input data sample, a weather attribute value, a velocity of an object, and a motion pattern of an object.

9. The method of claim 6, wherein the plurality of curation constraints includes at least one qualitative characteristic of a set of input data samples.

10. The method of claim 9, wherein the at least one qualitative characteristic comprises at least one of: a semantic context of an object, a composition of a plurality of objects, a plurality of parameter values of a plurality of coverage parameters in an input data sample, a variation between a plurality of compositions of a plurality of objects in the set of input data samples, and a rarity value of a composition of a plurality of objects.

11. The method of claim 6, further comprising modifying the plurality of curation constraints according to the plurality of required data sample characteristics.

12. The method of claim 1, further comprising:
collecting raw data from a plurality of data sources; and
adding to the data repository at least one other input data sample generated using at least some of the raw data.

13. The method of claim 12, wherein the plurality of data sources comprises at least one of:
a database, a sensor, an application programming interface and a human-machine interface.

14. The method of claim 1, further comprising training the machine learning model using one or more sets of training data selected from the data repository.

15. The method of claim 14, wherein the data repository stores a plurality of input data candidates; and
wherein at least one of the one or more sets of training data is produced by selecting from the data repository another plurality of input data candidates according to another plurality of curation constraints.

16. The method of claim 1, wherein the at least one new input data sample comprises at least one of: a digital image, a digital video, and a simulated signal simulating a signal captured from a sensor.

17. The method of claim 1, further comprising:
computing a plurality of visual features by analyzing an identified repository of data samples comprising a plurality of digital images captured in one or more physical environments; and
computing at least one dataset score using the plurality of visual features and at least one additional set of training data selected from the data repository, where the at least one dataset score is indicative of an expected performance score of the machine learning model in response to input data when the machine learning model is trained using the at least one additional set of training data;
wherein computing the plurality of required data sample characteristics is further according to the at least one dataset score and the plurality of visual features.

18. The method of claim 17, wherein the plurality of visual features comprises at least one of: an object attribute, an object attribute value, a sharpness value, a contrast value, a color value, a color combination, a color intensity value, a color brightness, a texture, a histogram of a digital image, a distance between objects, an object orientation, an object orientation relative to another object, an amount of objects in an input data sample, a weather attribute value, a velocity of an object, a semantic context of an object, an edge of an object, a positional relationship between two or more objects, and a motion pattern of an object.

19. A system for generating training data for a machine learning model comprising:
an analyzer component configured for:
accessing a plurality of output values of a machine learning model, computed thereby in response to a plurality of input data samples; and
analyzing the plurality of output values and the plurality of input data samples to compute a plurality of required data sample characteristics associated with at least one unsatisfactory output value of the plurality of output values; and
a data generator connected to the analyzer component and configured for:
generating at least one new input data sample using a plurality of generation constraints comprising provided therewith, where the plurality of generation constraints comprises the plurality of required data sample characteristics; and
adding the at least one new input data sample to a data repository for producing training data for the machine learning model;
wherein the at least one new input data sample comprises at least part of a simulated driving environment for training the machine learning model to operate in an autonomous automotive system.

20. A software product for generating training data for a machine learning model comprising:
a non-transitory computer readable storage medium;
first program instructions for accessing a plurality of output values of a machine learning model computed in response to a plurality of input data samples;
second program instructions for analyzing the plurality of output values and the plurality of input data samples to compute a plurality of required data sample characteristics associated with at least one unsatisfactory output value of the plurality of output values;
third program instructions for generating at least one new input data sample by providing a data generator with a plurality of generation constraints comprising the plurality of required data sample characteristics; and
fourth program instructions adding the at least one new input data sample to a data repository for producing training data for the machine learning model;
wherein the at least one new input data sample comprises at least part of a simulated driving environment for training the machine learning model to operate in an autonomous automotive system; and
wherein the first, second, third, and fourth program instructions are executed by at least one computerized processor from the non-transitory computer readable storage medium.
